(19) United States
(12) Patent Application Publication
(10) Pub. No.: US 2005/0079832 A1
(43) Pub. Date: Apr. 14, 2005

(54) Transducer design for rugged portable communications products

(76) Inventors: Shlomo Gelbart, Plantation, FL (US); Sankar Gopalasubramanian, Chandler, AZ (US)

Correspondence Address: AKERMAN SENTERFITT, P.O. BOX 3188, WEST PALM BEACH, FL, 33402-3188, US

(21) Appl. No.: 10/682,766

(22) Filed: Oct. 9, 2003

(51) Int. Cl. H04Q 7/20

(52) U.S. Cl. 455/90.3

(57) ABSTRACT

A transducer design (50) can include a transducer assembly (60, 59 and 56) having a frontal area (61), a housing (52) having a main port (64) forming a portion of a main volume (61, 62, and 70), and an area (58) defining a back volume. The back volume is contiguous with the main volume and the frontal area substantially enclosed by the housing defines at least a portion of the main volume. A main volume path (63) and a back volume path (65) can be combined within a common region (62). The main volume and back volume paths can be further defined using a sheet metal transducer (74) and a felt element (72) placed within the common region.

### CROSS-REFERENCE TO RELATED APPLICATIONS

Not applicable

### FIELD OF THE INVENTION

This invention relates generally to a transducer design, and more particularly to transducer design that combines a back volume port with a main volume port.

### BACKGROUND OF THE INVENTION

The cellular phone industry is constantly challenged in the market place for high-quality, low-cost products. Motorola's iDEN technology as marketed by NEXTEL has traditionally reached the blue-collar workforce creating a demand for ruggedized designs for phones. Given the design restrictions involved, a waterproof phone design presents a challenge. A very good example for such a restriction is the audio ports involved. Due to restrictions in the propagation of sound waves it is hard to achieve a water-tight design as far as audio is concerned. Old designs involved extensive porting for maximum air movement. A minimally intrusive design would involve extensive reduction in exposed areas thereby restricting the movement of air. Also transducer design requires a flat frequency response through the audible frequency range to create good quality sound reproduction. Typically sound is propagated through the free ports in three distinct paths. The first path is from the transducer to the outside of the housing which is generally referred to herein as the main path. The second path is from the ear volume (the volume between the ear and an external portion of the housing) to a surrounding volume around the housing which is generally referred to herein as the leakage path. The third path, referred to herein as the back volume path, connects the back volume behind the transducer to the outside.

With a ruggedized design, all these ports are covered by a special “water-proof” material to keep the inside of the radio dry. Additionally, the proximity of the transducer space typically includes the antenna circuitry, GPS circuitry or other circuitry while external from the transducer space includes industrial design aspects such as lenses, forcing the leak ports to be separated and far away from each other. The difficulties with this separation can be overcome by the use of felts and membranes, but results in a design that is very sensitive to the assembly of parts which would need to be tightly controlled. For example, the leakage path to the outside usually uses the tolerance stack up between the lens and the front housing. Thus, the number of ports involved in a typical transducer design requires a large number of parts which are typically very sensitive to assembly. Also the industrial design control over the appearance of the ports restricts the volume of air movement.

### SUMMARY OF THE INVENTION

In a first aspect of an embodiment of the present invention, a transducer design can include a transducer assembly having a frontal area, a housing having a main port forming a portion of a main volume, and an area defining a back volume. The back volume is contiguous with the main volume and the frontal area substantially enclosed by the housing defines at least a portion of the main volume.

In a second aspect, a portable electronic product having an improved transducer design includes a transducer assembly having a frontal area, a housing of the portable electronic product having a main port forming a portion of a main volume, and an area defining a back volume. The back volume is contiguous with the main volume and the frontal area substantially enclosed by the housing defines at least a portion of the main volume.

In a third aspect, an embodiment in accordance with the present invention can include a method of forming a transducer design including the steps of forming a main volume in a frontal area of a transducer, porting the main volume through a housing in front of the transducer, and porting a back volume in an area behind the transducer through the main volume. The method can optionally include the step of forming a leak path from the main volume to an external area.

### BRIEF DESCRIPTION OF THE DRAWINGS

FIG. 1 is a side view of an existing transducer design.

FIG. 2 is a side view of a transducer design in accordance with the present invention.

FIG. 3 is a side view of the transducer design of FIG. 2 further including sheet metal and felt in accordance with the present invention.

FIG. 4 is an exploded view of a mobile phone including a transducer design in accordance with the present invention.

FIG. 5 is a perspective view of a high impedance felt used for the transducer design of FIG. 4.

FIG. 6 is a perspective view of a piece of sheet metal used for the transducer design of FIG. 4.

FIG. 7 is a flow chart illustrating a method of forming a transducer design in accordance with the present invention.

### DETAILED DESCRIPTION OF THE DRAWINGS

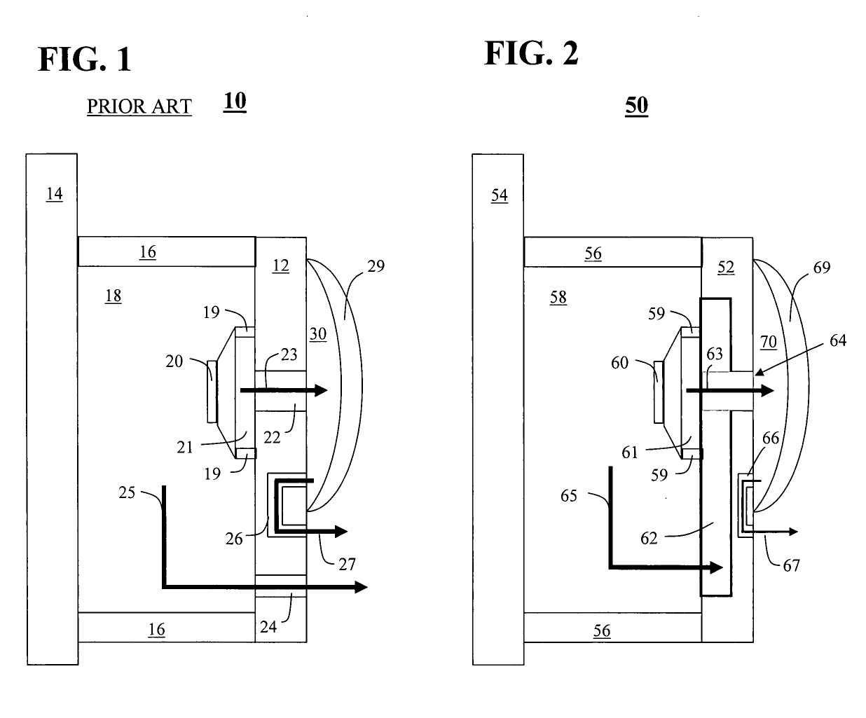

Referring to FIG. 1, an existing transducer design 10 illustrates the conventional three distinct paths and ports used in most designs. The transducer design 10 can include a transducer assembly including a transducer 20, a forward wall 19 and a peripheral wall 16. Both the forward wall 19 and the peripheral wall abut against a product housing 12 while the peripheral wall further abuts against a rear wall such as a substrate or printed circuit board 14. The region 18 behind the transducer 20 and generally between product housing 12 and substrate 14 is the back volume. The region 21 is formed between the front of the transducer 20 and the product housing 12. The region 22 is formed within the product housing 12 in front of the transducer 20. The region 30 is formed between the product housing 12 and a user's ear 29. The areas 21, 22 and 30 in combination forms the main volume. Thus, a main path 23 goes from the transducer 20 to the outside of the housing and a back volume path 25 connects the back volume behind the transducer 20 to the outside through a region 24 in the product housing 12. A leak or leakage path 27 is formed from the ear to an external portion of the housing 12 via a region 26 as shown. As mentioned above, in order to prevent intrusion of liquids in this particular design, each port would need to be covered with “waterproof” material (not shown).

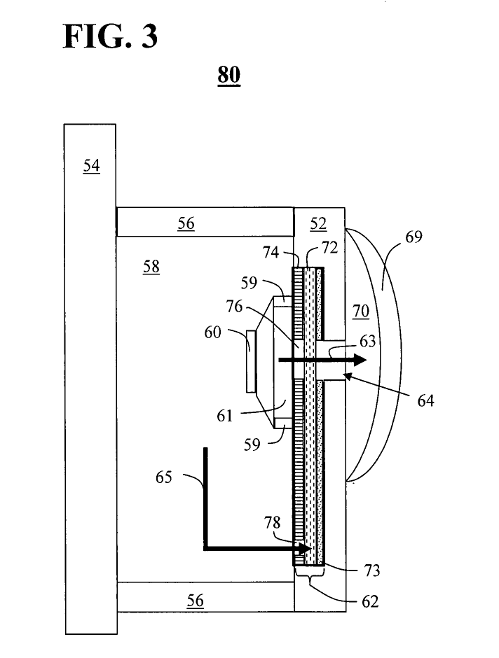

In contrast, an embodiment using the concepts of the present invention can be very simple since the main (or front) and the back volumes are combined together as shown in FIG. 2. As shown in FIG. 3, the front and back volumes of the transducer are combined together through one part (such as a felt part) outside to the ear which enables a single part to cover multiple ports. This arrangement enables the freedom to choose the ports and provides greater flexibility in sizing the ports without compromising performance. In other words, embodiments in accordance with the transducer design of the present invention are less dependent on the overall product assembly for porting.

Referring to FIG. 2, a transducer design 50 illustrates a more simple design in accordance with the present invention. The transducer design 50 can include a transducer assembly including a transducer 60, a forward wall 59 and a peripheral wall 56. Both the forward wall 59 and the peripheral wall 56 can abut against a product housing 52 while the peripheral wall 56 can further abut against a rear wall 54 such as a substrate or printed circuit board. The region 58 behind the transducer 60 and generally between product housing 52 and rear wall 54 is the back volume. The region 61 is formed between the front of the transducer 60 and the product housing 52. The region 62 is formed within the product housing 52 in front of the transducer 60. Note that the region 62 is contiguous with the back volume or region 58. The region 70 is formed between the product housing 52 and a user's ear 69. The regions 61, 62 and 70 in combination form the main volume. Thus, a main path 63 goes from the transducer 60 to the outside of the housing 52 and a back volume path 65 connects the back volume behind the transducer 60 to the main volume or front volume through the region 62 in the product housing 52. Note that the back volume and the main volume exit through a single main port 64 as opposed to two separate ports as in transducer design 10 of FIG. 1. The transducer design 50 can optionally include a leak or leakage path 67 formed from the ear to an external portion of the housing 52 via a region 66 as shown. The transducer design 50 does not necessarily require “waterproof” material, and thus none are shown in FIG. 2.

Referring to FIG. 3, a transducer design 80 quite similar to the transducer design 50 of FIG. 2 is shown. The transducer design 80 can be a ruggedized version of transducer design 50 of FIG. 2 since it further includes “waterproof” materials as will be further detailed below. The transducer design 80 can include as before a transducer assembly including a transducer 60, a forward wall 59 and a peripheral wall 56 abutting against a product housing 52 and a rear wall 54 as previously described. The regions 61, 62 and 70 are also formed as previously described and form the main volume in combination. Note that the region 62 is still contiguous with the back volume or region 58.

In this embodiment, the region 62 further includes a barrier such as a felt element 72 which can be an acoustic impedance felt that further prevents intrusion of liquids within the product housing. The felt element 72 can adhere to the product housing 52 using an adhesive layer 73 as shown. Also within the region 62 between the transducer 60 and the felt element 72 is a transducer sheet metal 74 that can further provide definition to the main port 64 and main path 63 via an aperture 76 in the sheet metal 74. Also note that the forward wall 59 can seal against the transducer sheet metal 74. The transducer sheet metal 74 can also include another aperture 78 that can further define the back volume path 65 towards the main path (through the aperture 78 and the felt element 72). Thus, as before, a main path 63 goes from the transducer 60 (through the aperture 76 in transducer sheet metal 74 and the felt element 72) to the outside of the housing 52 and a back volume path 65 connects the back volume behind the transducer 60 to the main volume or front volume through the region 62 in the product housing 52. Again note that the back volume and the main volume exit through the single main port 64 (via the felt element 72) as opposed to two separate ports as in transducer design 10 of FIG. 1. Also note that the leakage path being optional, none is shown in the embodiment of FIG. 3.

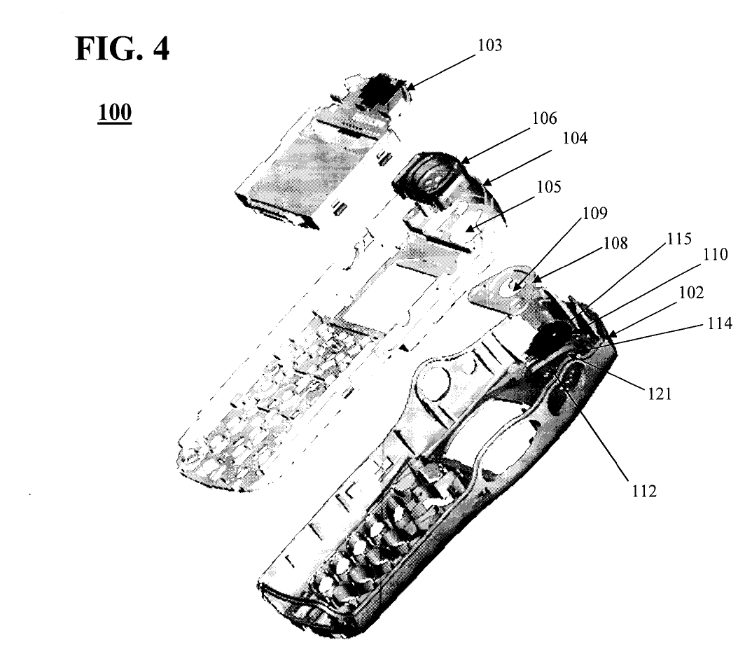

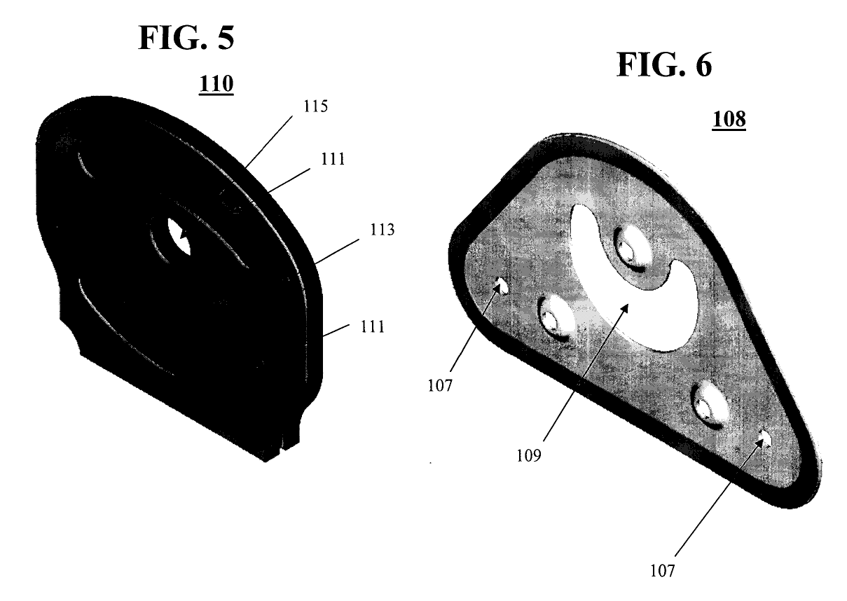

Referring to FIG. 4, an exploded view of a ruggedized mobile radio 100 is shown in accordance with an embodiment the present invention. The radio 100 can include a product housing 102 having at least one aperture 114 forming the main port for a transducer design. The aperture or apertures 114 preferably reside within a recessed area 112 of the product housing 102 that forms part of the main volume and enables the appropriate placement of a felt element 110, a transducer sheet metal 108, and a transducer assembly 106 (compare recessed area 112 with region 62 of FIG. 3). A housing 104 having an aperture 105 can also be used to further define the main volume formed in front of the transducer assembly 106. The felt element 110 can include an aperture 115 to enable the felt element 110 to register in place within the recessed area 112 using a post 121 protruding from the housing 102. The felt element 110 can include adhesive 113 on a first side of the element except in areas 111 as shown in FIG. 5. Areas 111 of the felt element abut against the aperture or apertures 114 of the product housing 102 and thus do not require adhesive. A back wall 103 can be provided to form the back volume using a substrate or printed circuit board that abuts against the rear portion of the transducer assembly 106.

Referring to FIG. 5, a larger perspective view of the felt element 110 is shown including the aperture 115, the adhesive area 113 and the (non-adhesive) area 111. Note that sound would primarily travel through the non-adhesive area(s) 111 and that the adhesive and non-adhesive areas shown are merely exemplary. Less adhesive can certainly be used and should generally not block the aperture(s) 114 of the product housing 102 (see FIG. 4) serving as the main port. Referring to FIG. 6, a larger perspective view of the transducer sheet metal 108 is shown. The transducer sheet metal includes an aperture 109 that defines the main port and main volume port for the transducer design (compare aperture 109 with aperture 76 of FIG. 3). The transducer sheet metal can further include at least one aperture 107 that servers as the back volume path that combines with the main volume through the felt element 110 (compare aperture 107 with aperture 78 of FIG. 3).

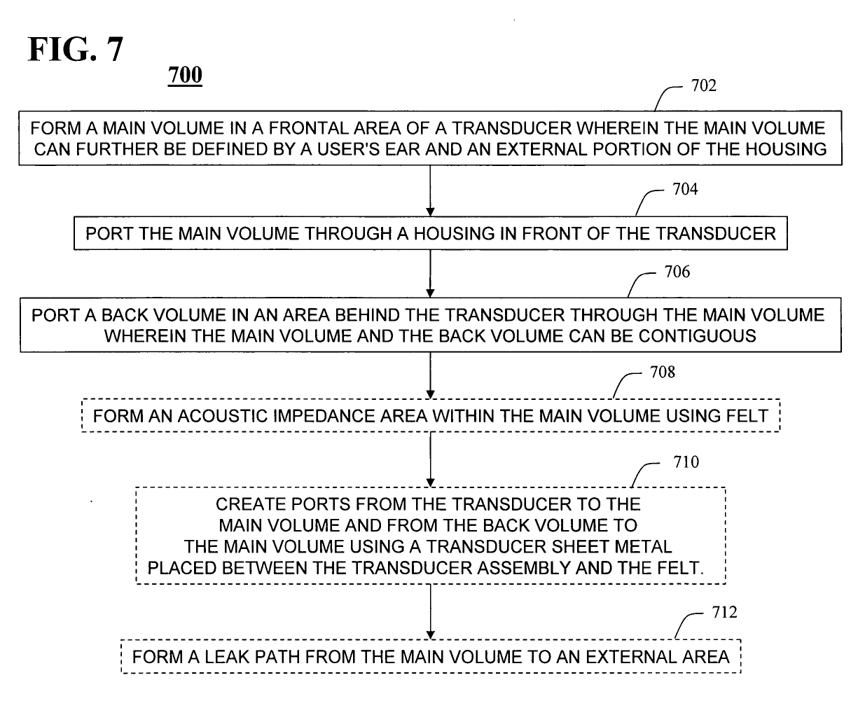

Referring to FIG. 7, a flow chart illustrating a method 700 of forming a transducer design is shown. The method 700 can include the step 702 of forming a main volume in a frontal area of a transducer wherein the main volume can further be defined by a user's ear and an external portion of the housing and the step 704 of porting the main volume through a housing in front of the transducer. At step 706, the method 700 can port a back volume in an area behind the transducer through the main volume wherein the main volume and the back volume can be contiguous. Optionally, the method 700 can form an acoustic impedance area within the main volume using felt at step 708 and further optionally create ports at step 710 from the transducer to the main volume and from the back volume to the main volume using a transducer sheet metal placed between the transducer assembly and the felt. Another optionally step 712 can form a leak path from the main volume to an external area.

In light of the foregoing description of the invention, it should be recognized that the present invention can be realized in various embodiments. Additionally, the description above is intended by way of example only and is not intended to limit the present invention in any way, except as set forth in the following claims.

1. A transducer design, comprising:
a transducer assembly having a frontal area;
a housing having a main port forming a portion of a main volume, wherein the frontal area substantially enclosed by the housing defines at least a portion of the main volume; and
an area defining a back volume, wherein the back volume is contiguous with the main volume.

2. The transducer design of claim 1, wherein a back volume path exits via the main port into the main volume.

3. The transducer design of claim 1, wherein the transducer design further comprises a leak path from the main volume to an external area.

4. The transducer design of claim 1, wherein the transducer design further comprises a barrier within the main volume.

5. The transducer design of claim 4, wherein the barrier is comprised of waterproof felt.

6. The transducer design of claim 4, wherein the transducer design further comprises a transducer sheet metal placed between the transducer assembly and the barrier.

7. The transducer design of claim 1, wherein the main volume is further defined by a user's ear and an external portion of the housing.

8. A portable electronic product having an improved transducer design, comprising:
a transducer assembly having a frontal area;
a housing of the portable electronic product having a main port forming a portion of a main volume, wherein the frontal area substantially enclosed by the housing defines at least a portion of the main volume; and
an area defining a back volume, wherein the back volume is contiguous with the main volume.

9. The portable electronic product of claim 8, wherein the portable electronic product is selected from the group comprising a portable two-way radio, a cellular phone, a laptop computer, a cordless phone, a personal digital assistant, and a portable radio receiver.

10. The portable electronic product of claim 8, wherein a back volume path exits via the main port into the main volume.

11. The portable electronic product of claim 8, wherein the transducer design further comprises a leak path from the main volume to an external area.

12. The portable electronic product of claim 8, wherein the transducer design further comprises a low audio felt within the main volume.

13. The portable electronic product of claim 12, wherein the transducer design further comprises a transducer sheet metal placed between the transducer assembly and the low audio felt.

14. The portable electronic product of claim 8, wherein the main volume is further defined by a user's ear and an external portion of the housing.

15. A method of forming a transducer design, comprising the steps of:
forming a main volume in a frontal area of a transducer;
porting the main volume through a housing in front of the transducer;
porting a back volume in an area behind the transducer through the main volume.

16. The method of claim 15, wherein the method further comprises the step of forming a leak path from the main volume to an external area.

17. The method of claim 15, wherein the main volume and the back volume are contiguous.

18. The method of claim 15, wherein the method further comprises forming an acoustic impedance area within the main volume using felt.

19. The method of claim 18, wherein the method further comprises the step of creating ports from the transducer to the main volume and the from the back volume to the main volume using a transducer sheet metal placed between the transducer assembly and the felt.

20. The method of claim 15, wherein the main volume is further defined by a user's ear and an external portion of the housing.
